(19) United States
(12) Patent Application Publication
(10) Pub. No.: US 2004/0267489 A1
(43) Pub. Date: Dec. 30, 2004

(54) Data compaction and pin assignment

(76) Inventors: Frederic Reblewski, Paris (FR); Gilles Laurent, Boulogne (FR); Philippe Diehl, Versailles (FR)

Correspondence Address: BANNER & WITCOFF, 1001 G STREET N W, SUITE 1100, WASHINGTON, DC, 20001, US

(21) Appl. No.: 10/602,020

(22) Filed: Jun. 24, 2003

(51) Int. Cl. G06F 15/00

(52) U.S. Cl. 702/127

(57) ABSTRACT

A method and system for compacting data and assignment to pins. A first sample of state data is received from a reconfigurable emulation resource. A set of the first sample of state data is stored into a first/current buffer. A second sample of state data is received. A determination is made as to whether the residual storage space of the first/current buffer is full and whether a set of the second sample needs to be portioned into two portions. The set of the second sample is stored in the first/current buffer to the extent it can be accommodated by the residual storage space of the first/current buffer. Any remaining portion of the set of the second sample is stored in a second/back-up buffer. Trace chains are assigned to trace pins based upon a schedule relating to the buffer fill rates.

### FIELD OF THE INVENTION

Aspects of the present invention are directed generally to the field of emulation, and more particularly to debugging resources and methods for efficient data compaction and efficient pin utilization.

### BACKGROUND OF THE INVENTION

Emulation systems typically were formed using emulation integrated circuits, including programmable logic devices (PLD), such as general-purpose field programmable gate arrays (FPGA), without integrating debugging facilities. To emulate a design on such an emulation system, the design would be “realized” by compiling a formal description of the design, partitioning the design into subsets, mapping various subsets to the logic elements (LE) of the emulation integrated circuits of various logic boards of the emulations system, and then configuring various interconnects to interconnect the logic elements. The partitioning and mapping operations typically would be performed on workstations that were part of or complementary to the emulation systems, while the configuration information correspondingly would be downloaded onto the logic boards hosting the emulation integrated circuits, and then onto the emulation integrated circuits.

During emulation of a design in a PLD, such as a field programmable device (FPD), test stimuli are generated on the workstation or on a service board of the emulation system under control of the workstation, and then transferred to various logic boards for input into the PLDs for application to the various netlists of the design being emulated. Correspondingly, state data of various circuit elements, which may include data of interest of the design being emulated, would be read out of the applicable PLDs and then transferred off the logic boards for analysis on the workstation.

With advances in integrated circuit and emulation technology, other emulation systems began to employ PLDs specifically designed for emulation purposes. These special PLDs typically would include a substantial amount of on-chip reconfigurable logic elements, interconnects, memory, and debugging resources. As advances in the technology field continue, an increasing number of these on-chip reconfigurable logic elements, interconnects, memory, and debugging resources are packed into each PLD. For example, a PLD can include a number of pins for transferring data captured by the debugging resources included with the PLD. As the number of reconfigurable emulation resources being included into a PLD increase, so does the number of user netlists that may be emulated by the PLD.

Accordingly, there is an increasing amount of data to be captured and outputted from a PLD. Thus, there becomes a problem of how to store, transfer, and/or otherwise handle all of this data. Although the cost of memory has decreased over the years, it is nevertheless expensive. Further, large amounts of memory also take up valuable real estate and require additional power, both of which are usually of limited availability in an emulation system. Additionally, pins, included with the emulation integrated circuit, may be limited due to size constraints to handle the entirety of the data. Thus, an improved approach to management of state data and pins is desired.

### SUMMARY OF THE INVENTION

There is therefore a need for an emulation system that can provide for sorting and/or compacting of data of interest from various samples of state data. One aspect of the invention provides an emulation debugging resource that may comprise a first select logic device for receiving samples of state data, sorting the state data to group data of interest and ignored data, and/or for extracting the data of interest from each sample. The emulation debugging resource may include a current buffer and a back-up buffer that receive the extracted data of interest in an alternating manner, so that, after one buffer becomes filled, the other buffer receives the extracted data of interest. A second select logic device may be provided as part of the emulation debugging resource to select between the current and back-up buffer in an alternating manner and to drain the selected buffer when the selected buffer becomes full. Further, the emulation debugging resource may include an output storage device for receiving the data drained from the selected buffer.

Another aspect of the invention provides for the assignment of the data drained from the selected buffer to pins on an emulation integrated circuit. A plurality of trace chains that may be received from a second select logic device may be coupled to a trace pin select logic device. The trace pin select logic device may assign a limited number of pins to the trace chains based upon a schedule stored in memory. The schedule may be based upon the rate at which each trace chain is received.

Other aspects of the invention allow for methods to be performed within an emulation debugging resource and/or an emulation integrated circuit. Still other aspects may comprise an emulation system. Some emulation systems may include a workstation and/or an emulator.

These and other features of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative embodiment of an emulation logic board in accordance with at least one aspect of the present invention;

FIG. 2 is a functional block diagram of an illustrative embodiment of an arrangement of logic boards in accordance with at least one aspect of the present invention;

FIG. 3 is a functional block diagram of an illustrative embodiment of a debugging resource of an emulation system in accordance with at least one aspect of the present invention;

FIG. 4A is a graphical representation of an illustrative embodiment for sorting state data in accordance with at least one aspect of the present invention;

FIG. 4B is a functional block diagram of an illustrative embodiment of a memory for storing sample state data information in accordance with at least one aspect of the present invention;

FIGS. 5A-5B are graphical representations of an illustrative embodiment for compacting state data, utilizing two buffers, in accordance with at least one aspect of the present invention;

FIGS. 6A-6B is another graphical representation of an illustrative embodiment for compacting state data, utilizing two buffers, in accordance with at least one aspect of the present invention;

FIG. 7 is a functional block diagram of an illustrative embodiment of an emulation integrated circuit wherein scheduling is utilized for sorted data of interest from more than one trace chain to be, assigned to a limited number of pins, in accordance with at least one aspect of the present invention;.

FIGS. 8A-8C show an illustrative embodiment of one example of pin assignment to trace chains during three clock cycles in accordance with at least one aspect of the present invention;

FIG. 9A is a functional block diagram of an illustrative embodiment of an emulation integrated circuit wherein two trace chains are outputting sorted data of interest at different rates in accordance with at least one aspect of the present invention;

FIG. 9B is a graphical representation of an illustrative embodiment of the scheduling of pin assignments to the two trace chains of FIG. 9A over time in accordance with at least one aspect of the present invention;

FIG. 10 is a flow chart of an illustrative method for improved management in the compacting of state data, in accordance with at least one aspect of the present invention;

FIG. 11 is an illustrative embodiment of a method for selecting and associating trace chains with pins in relation to a schedule, in accordance with at least one aspect of the present invention.

### DETAILED DESCRIPTION OF ILLUSTRATIVE EMBODIMENTS

In the following description of various illustrative embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

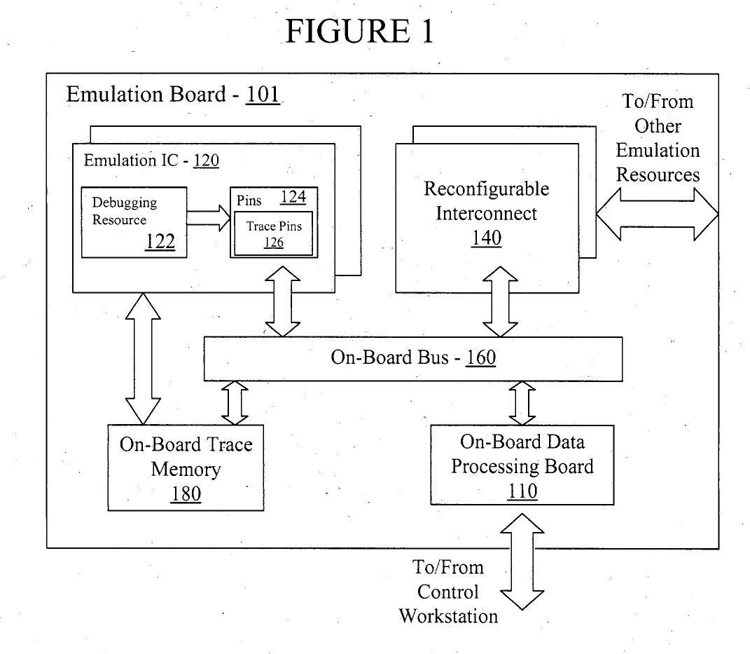

Referring to FIG. 1, an illustrative embodiment of an emulation board 101 may functionally include on-board data processing resources 110, at least one on-board emulation integrated circuit (IC) 120, at least one on-board reconfigurable interconnect 140, at least one on-board bus 160, and/or at least one on-board trace memory 180. Many of these components are indirectly coupled to each other through other components, such as through on-board bus 160 as shown in FIG. 1. Additionally, components may be directly coupled to other components, such as on-board emulation IC 120, which are directly coupled to on-board trace memory 180, as shown in FIG. 1. The term “emulation” is used broadly herein and includes not only pure hardware emulation, but also the combination of hardware emulation and software simulation, as well as hardware acceleration and/or co-simulation.

On-board ICs 120 may include various resources, such as reconfigurable logic elements (LE), reconfigurable interconnects, emulation memory, and context or state elements. As illustrated in FIG. 1, on-board ICs 120 include debugging resources 122 incorporating at least one aspect of the present invention. Additionally, a set of pins 124, including a set 126 dedicated to be used as trace pins for transporting trace data, is included in on-board ICs 120. In various embodiments of the present invention, each emulation IC 120 may include integrated debugging facilities, such as those incorporating enhanced FPGAs described in U.S. Pat. No. 5,777,489 to Barbier et al., entitled “Field Programmable Gate Array With Integrated Debugging Facilities,” and U.S. Pat. No. 6,265,894 to Reblewski et al., entitled “Reconfigurable Integrated Circuit With Integrated Debugging Facilities For Use In An Emulation System,” each of which is herein incorporated by reference as to their descriptions of such FPGAs.

Reconfigurable interconnects 140 facilitate coupling of the emulation resources of the various emulation ICs 120 of the different emulation boards 101 employed to form an emulation system. On-board bus 160 and trace memory 180 perform functions of facilitating on-board communication/data transfers, and collection of signal states of the various emulation signals of the assigned partition of the IC design being emulated.

As will be described in further detail, the debugging resource 122 receives and compacts state data from the emulation IC 120, and schedules the assignment of the state data to the pins 124. On-board bus 160, on-board trace memory 180, and reconfigurable interconnects 140 represent a broad range of buses, memory, and interconnects known in the art. Accordingly, these elements will not be described in detail below. State data may include trace data, data of interest, ignored data, and other types of data. Further, data of interest may include all of the state data, a subset of the state data, and other types of data.

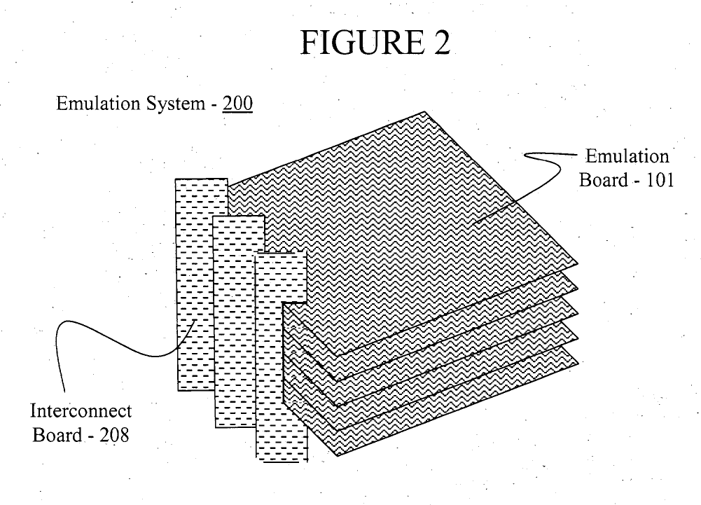

As shown in FIG. 2, emulation board 101 may be, included within an illustrative emulation system 200 formed using multiple ones of emulation board 101 incorporating the teachings of at least one aspect of the present invention. The emulation system 200 includes a number of emulation boards 101 coupled to each other via interconnect boards 208 and control resources, wherein data processing resources 110 of the various emulation boards 101 may be employed to perform, both locally and correspondingly (i.e., distributively), a number of emulation functions on behalf of and at the direction of the control resources. An example of such an emulation system is described in U.S. patent application Ser. No. 10/003,951, filed on Oct. 30, 2001, entitled “Emulation Components And Systems Including Distributed Routing And Configuration Of Emulation Resources,” to Reblewski.

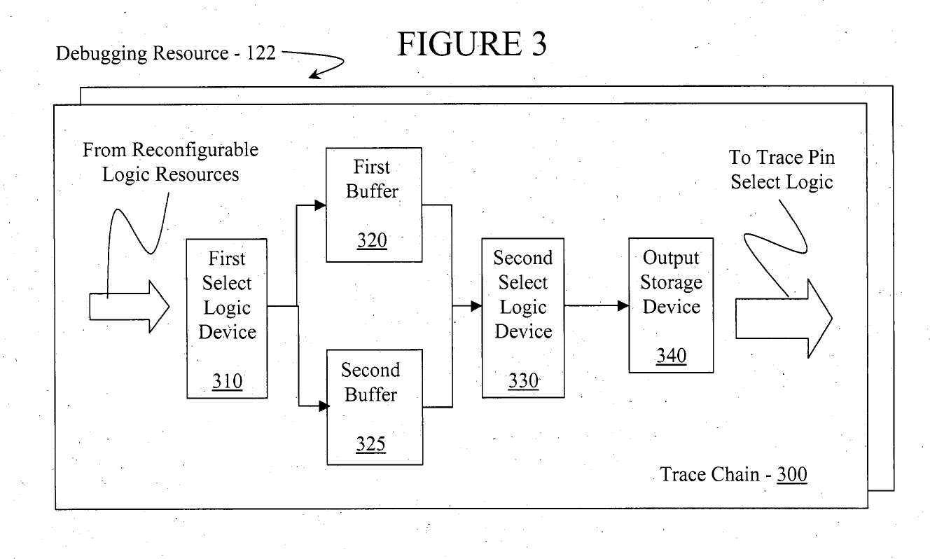

FIG. 3 illustrates a block diagram of illustrative debugging resource 122 in further detail, in accordance with at least one embodiment of the present invention. As illustrated in FIG. 2, debugging resource 122 may include a plurality of trace chains 300. Each trace chain 300 in this embodiment comprises a first select logic device 310, a first buffer 320, a second buffer 325, a second select logic device 330, and an output storage device 340 coupled to each other as shown.

In the embodiment illustrated in FIG. 3, the first select logic device 310 successively receives samples of state data read out from various state elements of the emulation design emulated by the reconfigurable resources included in the emulation IC 120. State data may include trace data, and the reconfigurable resources included in the emulation IC 120 may include reconfigurable logic resources (not shown). As will be described in further detail below, the first select logic device 310 (under the control of a control station in one embodiment) directs each of the successively received samples of state data to either the first buffer 320 or the second buffer 325 based at least upon determining whether the first buffer 320 or the second buffer 325 is full, in accordance with the teachings of at least one aspect of the present invention. Successively received samples of state data may be sorted, indexed to memory, and/or compacted into successive samples of sorted data, comprising data of interest.

The second select logic device 330 selects and outputs the sorted data stored in either the first buffer 320 or the second buffer 325, and provides such sorted data to the output storage device 340. As stated above, this state data stored in either the first buffer 320 or the second buffer 325 comprises the successive samples of sorted data comprising data of interest. Accordingly, second select logic device 330 facilitates emptying of the full buffer, whether it be first buffer 320 or second buffer 325, to the output storage device 340. The output storage device 340 facilitates receipt of the sorted and compacted samples of state data and provides them to an output node such as a physical pin 124, which may be coupled to a trace pin select logic for output. As will be described in further detail below, the trace pin select logic facilitates transmission of the sorted and compacted samples of state data off the emulation IC 120 via pins 124 (both shown in FIG. 1). The trace pin select logic may be operated by a control signal to assign sorted and/or compacted samples of state data to pins.

As used here, the term “empty” or “drain” as used herein includes not only the state in which all relevant data in a buffer has been cleared, but also where all relevant data has been read and is thus now considered old data. Further the process of “emptying” or “draining” as used herein includes the process of clearing data and of reading data and leaving the read data as old. The term “full” as used herein includes not only the state in which there is no more physical space in a buffer, but also where there is no more physical space within a specified portion of a buffer. The latter may occur, for instance, where the buffer is used to store other types of data. The process of “filling” as used herein includes the process of taking up the entire physical space of a buffer and the process of taking up the entire physical space of a specified portion of a buffer. In addition, the term “compacted data” as used herein includes the data from the process of sorting samples of state data and/or managing data of interest into buffers. The process of “compacting” as used herein includes the process of sorting samples of state data and/or storing data of interest into buffers and emptying the data from a filled buffer.

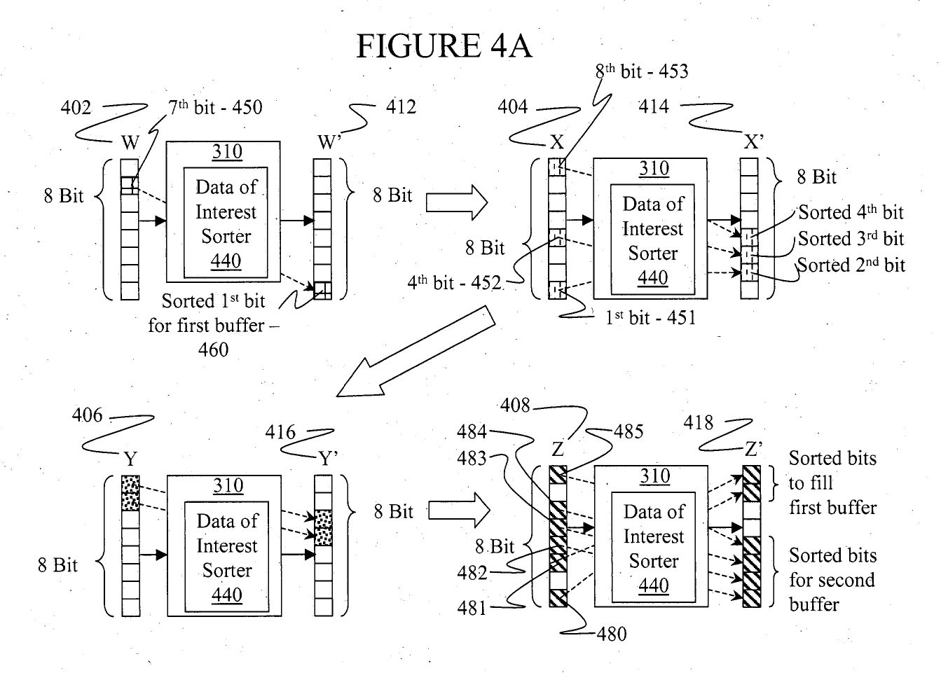

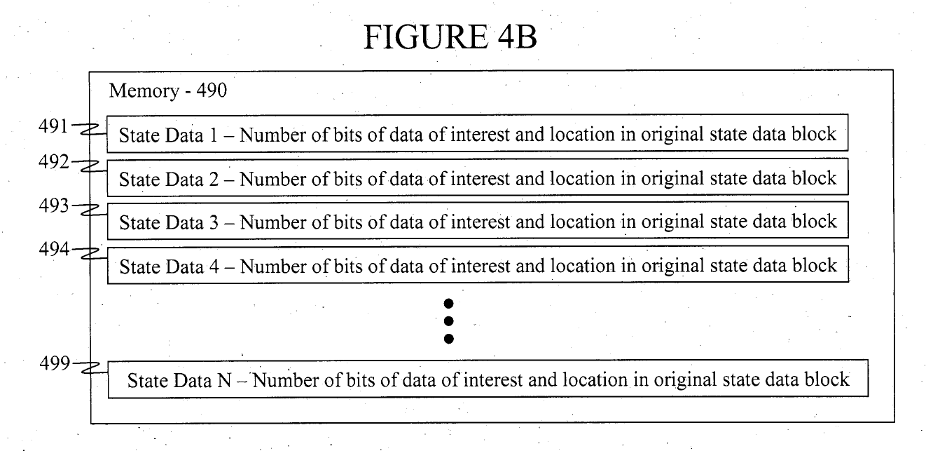

In the illustrated embodiment shown in FIG. 3, first select logic device 310 may be a device used for division of the successive samples of state data into at least two data groups: data of interest and ignored data. The data of interest may be outputted from the first select logic device 310 with the bit positions of the sample of state data having been shifted, as will be described below in reference to the illustrative embodiments in FIG. 4A below. A number of devices may be used for operation of a first select logic device 310 and a second select logic device 330, including, for example, any one or more switches, routers, and/or the like, such as crossbar(s), partial crossbar(s), and multiplexers, including shiftable multiplexers, along with a controller for controlling the same. Further, software may be used in conjunction with hardware elements, such as within the controller, to shift the bit positions of sample state data in the first select logic device 310. As for the first buffer 320 and second buffer 325, they may be of any type of buffer known for temporary storage of data, such as a first-in-first-out (FIFO) buffer, or even a memory such as a random-access memory (RAM). The second select logic device 330 may be any device capable of selectively receiving inputs from one of a plurality of sources and outputting the selected inputs, such as, but not limited to, a conventional multiplexer. The output storage device 340 may be any type of memory device, including one that is capable of receiving and outputting data sequentially, such as a FIFO buffer. The output storage device 340 may include information associated with the samples of state data, including information associated with data of interest.

FIG. 4A illustrates a graphical representation of an illustrative embodiment for sorting state data in accordance with at least one aspect of the present invention. As shown, state data 402, 404, 406, and 408 as well as sorted data 412, 414, 416, and 418 comprises eight bits of data. It should be understood by those skilled in the art that the present invention is not limited to eight bit data elements and that data may be organized in smaller or larger segments. Thus, state data 402, 404, 406, and 408 as well as sorted state data 412, 414, 416, and 418 may be any number of bits of data in any type of format.

As illustrated in FIG. 4A, the first select logic device 310 receives state data W 402. The first select logic device 310 comprises a data of interest sorter 440, for sorting state data. A data of interest sorter 440 may include a decoder and/or a controller. The controller may operate the decoder to sort the state data according to a predetermined operation, a consistent operation, or a changing operation. Further, the data of interest sorter 440 may include a memory or an access to a memory that contains information regarding the location of data of interest bits in a sample of state data. Data of interest sorter 440 may be software driven, hardware driven, or a combination of software and hardware driven.

State data W 402 comprises an 8-bit data block. In the illustration, the seventh bit 450 is the only bit of data of interest. The first select logic device 310 makes the determination of the data of interest. In this example, because state data W 402 is the first sample of state data and because the first buffer 320 is currently empty, the data of interest sorter 440 sorts the state data W 402 into sorted state data W′ 412 so that the seventh bit of data 450 is now the sorted first bit 460 for the first buffer. The dashed line represents the new bit position. The sorted state data W′ 412 comprises the same eight bits of data as in the original state data W 402, but the data of interest, in this case the seventh bit 450, has been sorted to fill the next available space within the residual storage space of the first buffer 320. Since the first buffer 320 was empty, the seventh bit 450 has been sorted to occupy the first bit 460 for the first buffer. In this case, the first select logic device 310 determines that the first buffer 320 is the current buffer. The process could allow for sorting into other bit positions where residual storage space within a first buffer exists.

Similarly, as the second sample of state data X 404 is received by the first select logic device 310, the three bits of data of interest in the state data X 404 are sorted to occupy bit positions two, three, and four of the sorted state data X′ 414, as shown by the dashed lines. Bit position one of the sorted state data X′ 414 is not occupied by any data of interest as the first/current buffer 320 already has the single data of interest bit of state data W 402 in bit position one. Further, the third sample of state data Y 406 is received by the first select logic device 310 and the two bits of data of interest in the state data Y 406 are sorted to occupy bit positions five and six of the sorted state data Y′ 416, again as shown by the dashed lines.

When the fourth sample of state data Z 408 is received by the first select logic device 310, the six bits of data of interest in the state data Z 408 are sorted as with state data W 402, X 404, and Y 406. However, in this example, the first select logic device 310 determines that the data of interest bits from sample state data Z 408 cannot be stored in the first/current buffer 320 as there are currently only two bit positions left, compared to the six bits of data of interest from sample state data Z 408. As such, the first two bits of data of interest (first bit 480 and third bit 481) are sorted into bit positions seven and eight of the sorted state data Z′ 418, as shown by the dashed lines. Further, the remaining bits of data of interest (fourth bit 482, fifth bit 483, sixth bit 484, and eight bit 485) from the sample of state data Z 408 are sorted into bit positions one through four of the sorted state data Z′ 418, as shown by the dashed lines. As will be explained below, bit positions one through four of the sorted state data Z′ 418 are for bit positions one through four of the second buffer 325. Once the first/current buffer 320 becomes full, such as in this example, the second buffer 325 assumes the role of first current buffer. The first buffer 320 is now the back-up buffer waiting until the current/second buffer becomes full.

FIG. 4B illustrates illustrative contents of memory 490 for storage of information relating to the various sample state data that are being received by the first select logic device 310. The memory 490 may be of any type of one or more memory devices, such as random access memory (RAM), and further may be local to or external from the first logic select device 310, the trace chain 300, the debugging resource 122, or any other potential location for storage of sample state data information. As shown in FIG. 4B, memory 490 is indexed by sample state data 1 491, state data 2 492, state data 3 493, state data 4 494, and on through state data N 499. The memory 490 may be indexed or arranged to store any number of sample state data.

Each entry 491, 492, 493, 494, and 499 comprises various types of information. As illustrated in FIG. 4B, entry 491 may include the number of bits of data of interest in the sample state data 1 as well as the location of each bit of data of interest in the original sample of state data 1. For example, referring to FIG. 4A, for state data X 404, an entry in memory 490 would include three bits of data of interest and the location of each bit of the three bits of data of interest in the original sample of state data X 404 would be bit position one, bit position four, and bit position eight. FIG. 4B is merely for illustrative purposes and other information concerning each sample of state data may be stored in memory 490. Other examples of information that may be stored may include the corresponding bit locations in the sorted state data of each bit of data of interest, whether every bit of data of interest from a sample of state data is stored in one buffer, whether the data of interest from a sample state data were portioned into two buffers, and which bits were portioned into the first buffer 320 and which were portioned into the second buffer 325. Still another example of information that may be stored is the assigned pin location/number for each trace chain. Other types of information may be stored and this illustration merely describes one use.

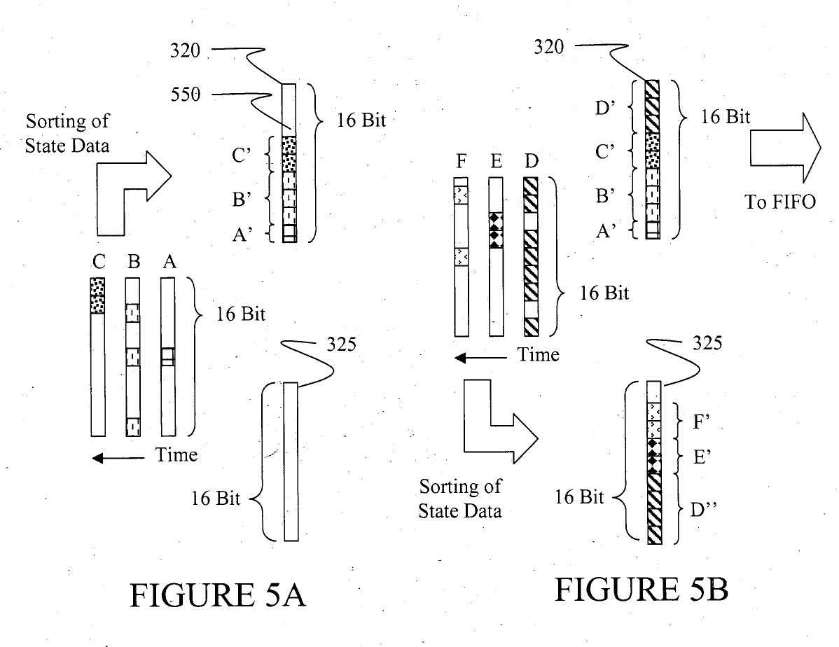

FIGS. 5A and 5B illustrate compaction of successive samples of state data utilizing two buffers, in accordance with at least one aspect of the present invention. Illustrated in FIGS. 5A and 5B, a number of samples of state data A-F are successively received by the first select logic device 310 (shown in FIG. 3). In FIGS. 5A and 5B, each of the samples of state data A-F are illustrated as comprising 16 bits, and the first/current buffer 320 and second/back-up buffer 325 are illustrated as comprising 16 bits. It should be noted that those in the art understand that the choice of 16 bits is merely for illustration purposes. The particular length of the sample state data may be any length or format and the first/current buffer 320 and second/back-up buffer 325 may be of any size or format as well.

Referring now to FIG. 5A, a first sample of state data A is received from the reconfigurable emulation resource, such as, but not limited to, reconfigurable logic resources included in the emulation IC 120. The first select logic device 310 selects a set of the sample state data A, such as the data of interest. The set of the first sample of state data A is stored in the first/current buffer 320, and is shown as A′ in the first/current buffer 320. The set of the first sample of state data A includes a subset of the sample state data and the entire sample state data as well as a set of the sorted state data and the entire sorted state data. The first sample of state data may be sorted as described above in reference to FIGS. 4A and 4B. As illustrated for this embodiment, the first sample of state data A is 16 bits in length; however, it is known by those skilled in the art that the state data may be fewer than 16 bits, resulting in the first/current buffer 320 not being full, even after storing the data of interest A′ of the first sample of state data A.

The first select logic device 310 at a later point in time receives a second sample of state data B. Similarly, the data of interest is selected. However, before storing the data of interest of the second sample state data B, the first select logic device 310 determines if the remaining available space in the first/current buffer 320 is sufficient to accommodate the selected data of interest. If it is determined that the first/current buffer 320 has sufficient residual storage space to store the selected data of interest, the selected data of interest is stored in the first/current buffer 320. Accordingly, the selected data of interest of the second sample state data B is also illustrated as being stored in the first/current buffer 320, and is shown as B′ in the first/current buffer 320.

In one embodiment, the process of determining if the first buffer 320 or the second buffer 325 has enough residual space may be performed each time a sample state data is received by the first select logic device 310. There are a number of ways to determine whether enough residual space in a buffer exists. One way includes checking a corresponding counter of the buffer that is decremented each time by the amount of data stored into the buffer. If the counter indicating the remaining number of bits that can be stored is larger than the sample state data, the entire sample state data is stored in the buffer.

As illustrated in FIG. 5A, the first/current buffer 320 has enough residual storage space to store the selected data of interest B′ and still has residual storage space 550 even after the selected data of interest B′ of the second sample state data B has been stored in the first/current buffer 320. When a third sample of state data C is received by the first select logic device 310, assuming the data of interest is also smaller in size than the available residual space 550, the data of interest is also stored in the first/current buffer 320 and is shown as C′ in the first/current buffer 320.

Referring now to FIG. 5B, a fourth sample of state data D is received by the first select logic device 310. The partially filled first/current buffer 320 of FIG. 5A includes residual storage space 550. As illustrated in FIG. 5B, in this instance the first select logic device 310 determines that the data of interest of the fourth sample of state data D may be larger in size than the residual storage space 550 in the first/current buffer 320 of FIG. 5A. Accordingly, in FIG. 5B, a portion of the data of interest, small enough in size to be stored in the residual storage space 550 (shown in FIG. 5A), is stored in the first/current buffer 320 and is shown as D′ in the first/current buffer 320. As such, the first/current buffer 320 is full of data of interest from various sample state data. Since the data of interest of the fourth sample of state data D is larger in size than the residual storage space 550 (shown in FIG. 5A), the remaining portion of the data of interest is stored in the second/back-up buffer 325, and is shown as D″ in the second/back-up buffer 325. At this point, once the first buffer 320 becomes full, the second buffer 325 assumes the role of being the current buffer. Thereafter, as illustrated, the second/current buffer 325 continues to be filled by data of interest of a fifth sample of state data E and data of interest of a sixth sample of state data F, and shown as E′ and F′ respectively in the second/current buffer 325. Subsequent samples of state data are stored in the second/current buffer 325 until the second buffer 325 is full. Once the second buffer 325 is full, any further data of interest is sent back to the now emptied first buffer 320. Again, because the second buffer 325 becomes full, the first buffer 320 again assumes the role of being the current buffer. This process of alternating between buffers may continue until there is no more data of interest.

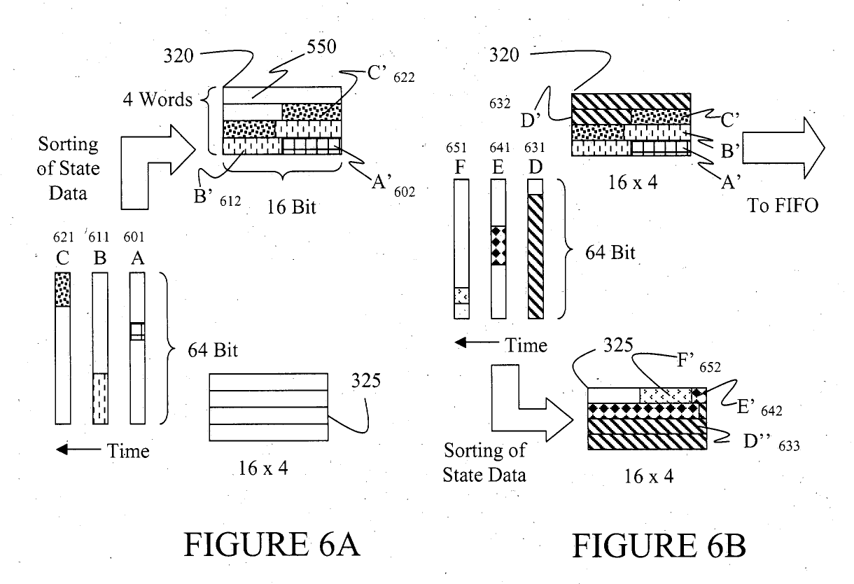

FIGS. 6A and 6B illustrate compaction of successive samples of state data utilizing two buffers, in accordance with one embodiment of the present invention. Illustrated in FIGS. 6A and 6B, a number of samples of state data A-F are successively received by the first select logic device 310 (shown in FIG. 3). In FIGS. 6A and 6B, each of the samples of state data A-F are illustrated as comprising 64 bits, and the first buffer 320 and second buffer 325 are illustrated as comprising 4 words, each of 16 bits in length. It should be noted that those in the art understand that the choice of 64 bits and 4 words, each of 16 bits, is merely for illustration purposes. The particular length of the sample state data may be any length or format, and the first buffer 320 and second buffer 325 may be of any size or format as well.

In FIGS. 6A and 6B, the first buffer 320 and the second buffer 325 happen to have sufficient capacity to store the entire contents of a sample state data. However, in other embodiments, the first buffer 320 and the second buffer 325 may have the capacity to contain fewer or more bits than a sample state data, including any number of bits N. Furthermore, the output storage device 340 (shown in FIG. 3) may be any size or format as well, including M “samples” deep, such as (M×N).

Referring now to FIG. 6A, a first sample of state data A 601 is received from the reconfigurable emulation resource, such as, but not limited to, reconfigurable logic resources included in the emulation IC 120. The first select logic device 310 selects a set of the sample state data A 601, such as the data of interest. The data of interest 602 of the first sample of state data A 601 is stored in the first buffer 320, and is shown as A′ in the first buffer 320. As illustrated for this embodiment, the first sample of state data A 601 is 64 bits in length; however, it is known by those skilled in the art that the state data may be fewer than 64 bits, resulting in the first buffer 320 not being full, even after storing the data of interest A′ 602 of the first sample of state data A 601.

The first select logic device 310 at a later point in time receives a second sample of state data B 611. Similarly, the data of interest is selected. However, before storing the data of interest 612 of the second sample state data B 611, it is determined if the remaining available space in the first buffer 320 is sufficient to accommodate the selected data of interest 612. If it is determined that the first buffer 320 has sufficient residual storage space to store the selected data of interest 612, the selected data of interest 612 is stored in the first buffer 320. Accordingly, the selected data of interest 612 of the second sample state data B 611 is also illustrated as being stored in the first buffer 320, and is shown as B′ in the first buffer 320.

As illustrated in FIG. 6A, the first buffer 320 has enough residual storage space to store the entire selected data of interest B′ 612 and still has residual storage space 550 even after the selected data of interest B′ 612 of the second sample state data B 611 has been stored in the first buffer 320. When a third sample of state data C 621 is received by the first select logic device 310, assuming the data of interest 622 is also smaller in size than the available residual space 550, the data of interest 622 is also stored in the first buffer 320 and is shown as C′ in the first buffer 320.

Referring now to FIG. 6B, a fourth sample of state data D 631 is received by the first select logic device 310. The partially filled first buffer 320 of FIG. 6A includes residual storage space 550. As illustrated in FIG. 6B, in this instance the first select logic device 310 determines that the data of interest (632 and 633) of the fourth sample of trace data D 631 is larger in size than the residual storage space 550 in the first buffer 320 of FIG. 6A. Accordingly, in FIG. 6B, a portion 632 of the data of interest (632 and 633), small enough in size to be stored in the residual storage space 550 (shown in FIG. 6A), is stored in the first buffer 320 and is shown as D′ in the first buffer 320. As such, the first buffer 320 is full of data of interest from various sample state data. Since the data of interest (632 and 633) is larger in size than the residual storage space 550 (shown in FIG. 6A), the remaining portion 633 of the data of interest (632 and 633) is stored in the second buffer 325, and is shown as D″ in the second buffer 325. Thereafter, as illustrated, the second buffer 325 continues to be filled by data of interest 642 of a fifth sample of state data E 641 and data of interest 652 of a sixth sample of state data F 651, and shown as E′ and F′ respectively in the second buffer 325. Subsequent data of interest is stored in the second buffer 325 until the second buffer 325 is full. Once the second buffer 325 is full, any further data of interest is sent back to the now emptied first buffer 320. Again, because the second buffer 325 becomes full, the first buffer 320 again assumes the role of being the current buffer. This process of alternating between buffers may continue until there is no more data of interest.

Therefore, fill buffers 320 and 325 are employed in an alternating manner, switching from one buffer to the other, when the current buffer becomes full. Moreover, data of interest from one sample of state data may be portioned and stored in both buffers when a residual storage space in the current buffer is not large enough to store the entire data of interest.

In FIG. 6B, once the first buffer 320 is full, data of interest of sample state data A′, B′, C′ and D′ are selected by the second select logic device 330 for output. The second select logic 330 (shown in FIG. 3) facilitates emptying of the first or second buffers 320 and 325 to the output storage device 340, upon determining that the first buffer 320 or second buffer 325 is full. Accordingly, referring to FIG. 6B, once the second buffer 325 is full, the first buffer 320, already having been emptied, is ready to be filled again, while the second buffer 325 is being emptied. Utilization of the two buffers 320 and 325 and selection of data of interest of the successively samples of state data may result in improved management of the state data.

With respect to a single trace chain 300, the embodiment illustrated in FIGS. 6A and 6B shows at least one aspect of the present invention. However, it should be appreciated by those skilled in the art that the debugging resource 122 may include multiple trace chains.

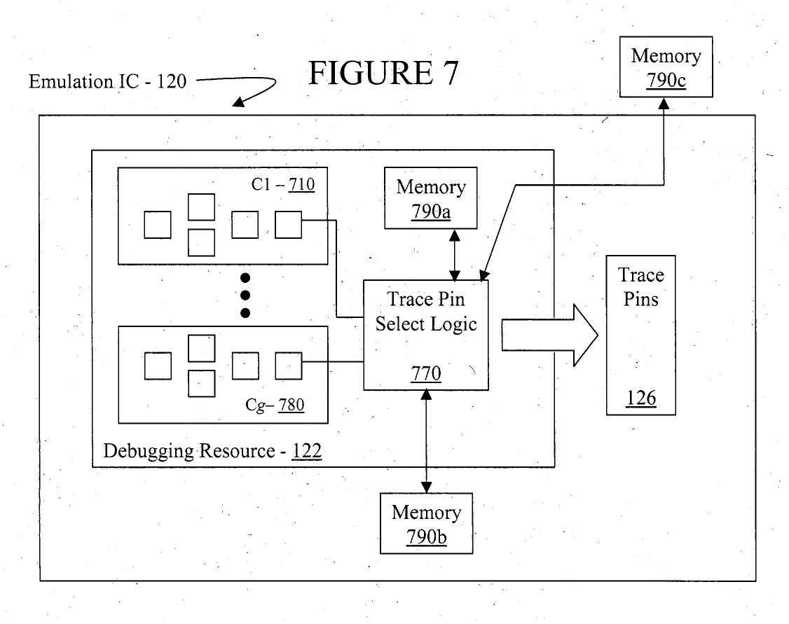

FIG. 7 illustrates another aspect of the invention, wherein scheduling is utilized for data of interest (preferably compacted as described above) from more than one trace chain to be transferred on a limited number of pins, in accordance with an illustrative embodiment of the present invention. Trace chains C1 710 to Cg 780 may have functions that are substantially the same as their above described counter part, trace chain 300 illustrated in FIG. 3. As illustrated in FIG. 7, the emulation IC 120 includes debugging resource 122, a memory 790a, a memory 790b, and/or a memory 790c (collectively, memory 790), and/or trace pins 126. The debugging resource 122 includes a plurality of g trace chains identified as C1 710 to Cg 780 and a trace pin select logic device 770. As illustrated, each of the trace chains C1 710 to Cg 780 is coupled to a trace pin select logic device 770. The trace pin select logic device 770 is coupled to memories 790a, 790b, and/or 790c. Memory 790 is illustrated as being located within the debugging resource 122 (memory 790a), within the emulation IC 120 (memory 790b), and/or external to the emulation IC 120 and/or debugging resource 122 that includes the trace pin select logic device 770 (memory 790c). For example, memory 790c may comprise, or be included within, on-board trace memory 180. These are merely examples of possible location(s) of memory 790.

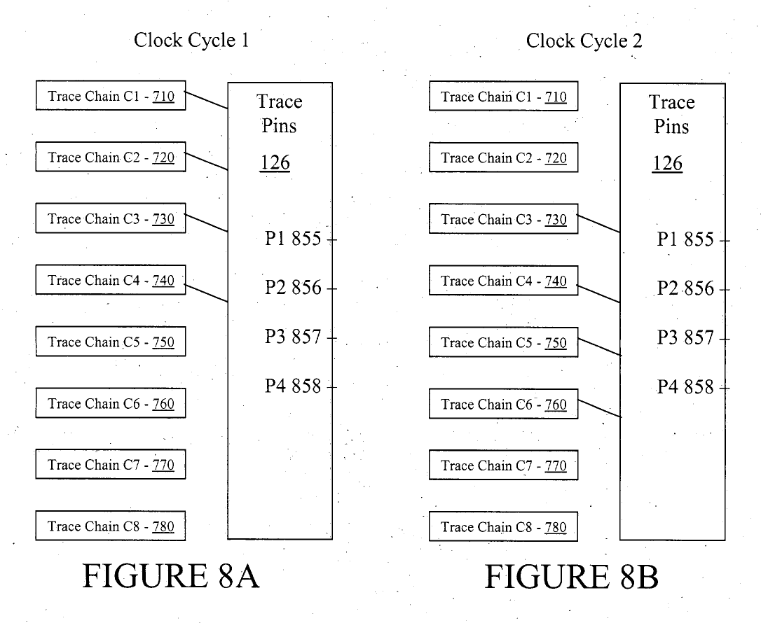

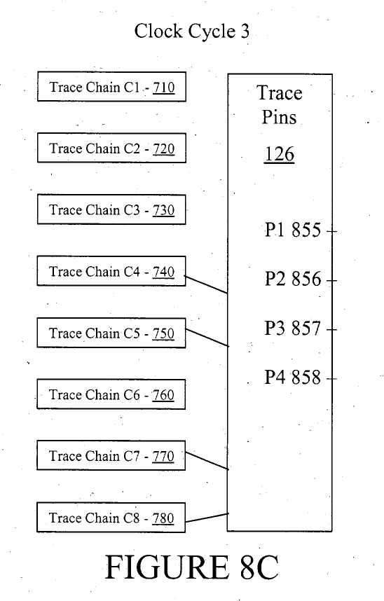

As described above, the trace chains C1 710 to Cg 780 provide compacted data of interest of successively samples of state data to the trace pin select logic device 770 to be transferred off the emulation IC 120 via trace pins 126 for debugging analysis. The trace pin select logic device 770 successively selects outputs of the trace chains, and routes the outputs of sorted and compacted data of interest of the selected trace chains to the available trace pins 126. The selected trace chains and available trace pins may change from clock cycle to clock cycle. As shown in FIG. 8A, where g=8, during a first clock cycle, trace chains C1 710, C2 720, C3 730, and C4 740 are given access to trace pins P1 855, P2 856, P3 857, and P4 858 to output their contents. As shown in FIG. 8B, during a second clock cycle, trace chains C3 730, C4 740, C5 750, and C6 760 are given access to trace pins P1 855, P2 856, P3 857, and P4 858 to output their contents. As shown further in FIG. 8C, during a third clock cycle, trace chains C4 740, C5 750, C7 770, and C8 780 are given access to trace pins P1 855, P2 856, P3 857, and P4 858 to output their contents. Thus, in these illustrations, the content of trace chain C4 740 always has access to a trace pin, whereas the contents of trace chain C3 730 and C5 750 have access during two out of every three clock cycles, and contents of trace chains C1 710, C2 720, C6 760, C7 770, and C8 780 have access during one out of every three clock cycles, thereby allowing for sharing of four trace pins by eight trace chains. Assignment of a pin to a trace chain output is coordinated by multiplexing and controlling the outputs based on their respective rate of output from their trace chain. The output rates are not constant; they can change during the emulation process.

As will be described in further detail below, the memory 790 facilitates scheduling for association of the trace chains C1 710 to Cg 780 with the trace pins 126 based at least upon the rate at which trace chains C1 710 to Cg 780 are provided with the sorted and compacted samples of state data. In other words, the scheduling for association of trace chain data with trace pins 126 for output may be based upon the rate the buffers, 320 or 325, within the respective trace chains 300 are filled. Software can determine an algorithm for proper and efficient assignment of pins to trace chains. A cyclic algorithm simply cycles through the available pins as trace chain outputs become available. If five (5) buffers are filled to be outputted, trace pins 801 to 805 may be utilized. When four (4) more trace chains output, trace pins 806, 807, 808, and 801 are utilized. Then, if three (3) more trace chains output, trace pins 802-804 are utilized. The process continues by cycling through the 8ight (8) trace pins.

As stated above, in FIG. 7, for ease of understanding, only two trace chains C1 710 and Cg 780 are explicitly shown. However, it should be appreciated by those skilled in the art that the number of trace chains may be any number. The trace pin select logic device 770 may be a device used for receiving inputs from g sources, and selectively coupling a set of S of the g sources to S output destinations, i.e., or the trace pins 126.

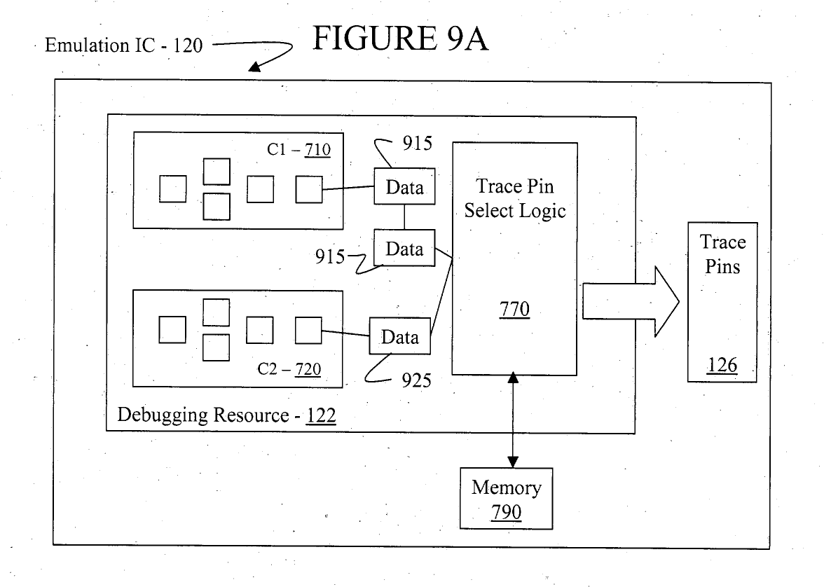

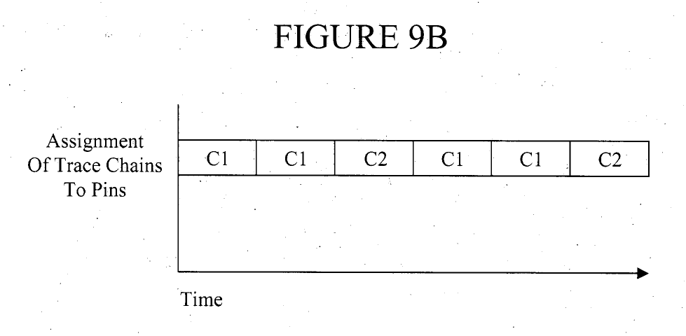

FIG. 9A illustrates one example where a first trace chain C1 710 outputs sorted and compacted data 915 at a rate that is different from the rate that a second trace chain C2 720 outputs sorted and compacted data 925. In the illustration of FIG. 9A, the rate at which the samples of data are provided to the first trace chain C1 710 is, e.g., twice that of the second trace chain C2 720 (determined, for example, at compile time mapping the design to be emulated to the emulation resources). Accordingly, the rate at which the first trace chain C1 710 should be drained is twice that of the second trace chain C2 720. The trace pin select logic device 770 is accordingly programmed (for example, by the control software resident on the control workstation) to schedule the utilization of the trace pins 126 to reflect the relative usage need. The utilization of the trace pins 126 may be scheduled based at least upon the rate at which the samples of state data are received by the respective trace chains.

Where the samples of state data are received by the first trace chain C1 710 at a rate that is twice that of the rate at which samples of state data are received by the second trace chain C2 720, memory 790 facilitates the operation of the trace pin select logic device 770 to provide the sorted and compacted data from the first trace chain C1 710 to trace pins 126 (making the trace pins 126 accessible to trace chain C1 710) at a rate that is twice that of the sorted and compacted samples of data from the second trace chain C2 720. The trace pin select logic device 770 determines the pin assignment based upon the rates of each of the trace chains, which may be stored in memory 790. Graphically, the scheduling by the trace pin select logic device 770 and memory 790 may be illustrated as shown in FIG. 9B. Although shown as a consistent 2:1 ratio for output from trace chain C1 710 compared to trace chain C2 720, the rates for any of the plurality of trace chains may change and the system may be designed to periodically check on the rates of output from each trace chain.

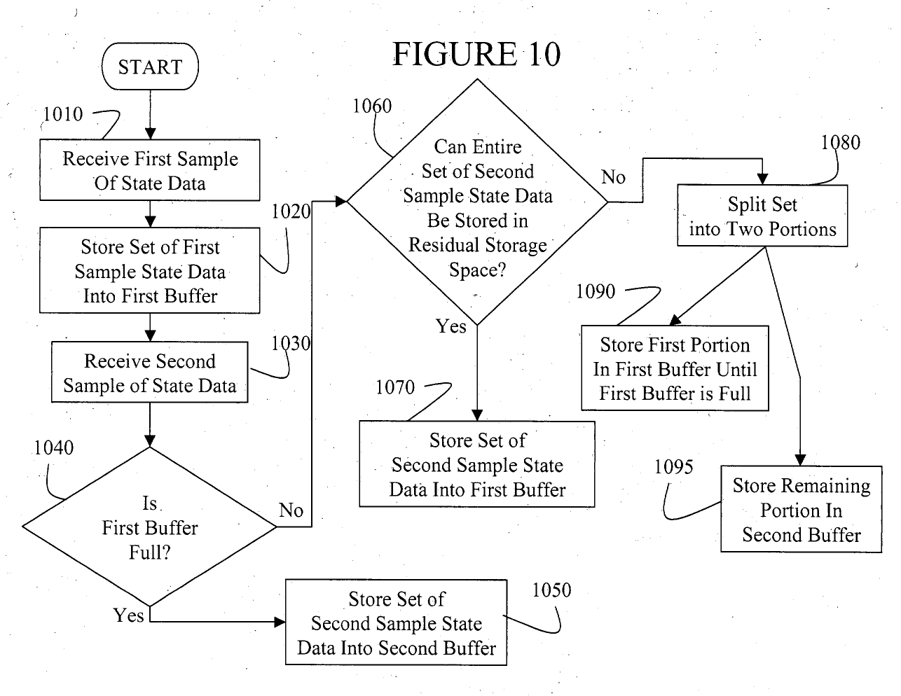

FIG. 10 illustrates an illustrative method for improved management in the compaction of state data, in accordance with at least one aspect of the present invention. At step 1010, a first sample of state data output from a reconfigurable emulation resource is received. At step 1020, data of interest of the first sample of state data is stored into a first buffer. At step 1030, a second sample of state data is received from the reconfigurable emulation source.

At step 1040, it is determined whether the first buffer is full. Accordingly, if it is determined that the first buffer is full, data of interest of the second sample state data is stored into a second buffer, at step 1050. Further, because the first buffer is full, the first buffer may be emptied into a second select logic device. However, if it is determined that the first buffer is not full, a second determination step 1060 is made. At step 1060, it is determined whether the residual storage space in the first buffer is sufficient to accommodate storage of the data of interest of the second sample of state data. If the residual storage space is large enough to accommodate the data of interest of the second sample of state data, at step 1070, the data of interest of the second sample of state data is stored in the first buffer. If the residual storage space is not large enough to accommodate the data of interest of the second sample of state data, at step 1080, the data of interest of the second sample of state data is split into two portions. At step 1090, one portion is stored in the first buffer to make the first buffer full and, at step 1095, the remaining portion of the data of interest of the second sample state data is stored in the second buffer.

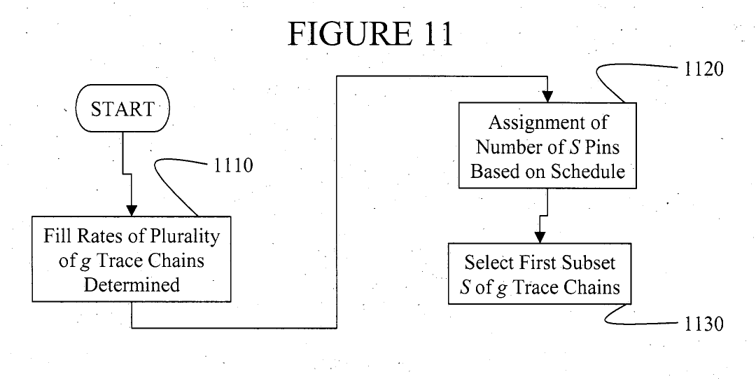

FIG. 11 illustrates a method for selecting and associating trace chains with pins in relation to a programmed schedule, in accordance with at least one aspect of the present invention. The scheduling is used to assign a relatively large number of trace chains to a limited number of pins, to facilitate shared use of the pins by the trace chains, and to output the data of interest (preferably compacted) of the trace chains, in accordance with at least one aspect of the present invention.

The rates at which a plurality of g trace chains is filled by data of interest (preferably compacted) are determined at step 1110. Once the fill rates are determined, at step 1120, a schedule of a number of S pins to provide corresponding sufficient drain rates to the g trace chains is determined based at least upon the determined fill rates from step 1110. At step 1130, a first set S of the g trace chains is selected and associated with S pins in accordance with the programmed schedule. For so long as the emulator is operating in a trace debugging mode, step 1130 is repeated, that is a second set of S of the g trace chains is selected and associated with the S pins.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method for compacting state data of an emulation system, comprising steps of:
receiving a first sample of state data;
sorting the first sample;
determining if residual storage space in a first buffer exists; and
storing the sorted first sample.

2. The method of claim 1, further comprising a step of determining whether the first buffer is full after storing the sorted first sample in the first buffer.

3. The method of claim 1, further comprising a step of portioning the sorted first sample into two portions.

4. The method of claim 3, wherein the step of storing the sorted first sample comprises storing a portion of the sorted first sample in the first buffer, and storing a remaining portion of the sorted first sample in a second buffer.

5. The method of claim 4, wherein the portion of the sorted first sample fills the first buffer.

6. The method of claim 5, wherein the second buffer assumes the role of the first buffer and the first buffer assumes the role of the second buffer.

7. The method of claim 5, further comprising the step of draining the first buffer into an output storage device.

8. The method of claim 1, further comprising steps of:
receiving a second sample of state data;
sorting the second sample; and
storing-the sorted second sample.

9. The method of claim 8, wherein the step of storing the sorted second sample comprises:
determining if residual storage space in the first buffer exists after storing the sorted first sample; and
storing at least a portion of the sorted second sample in the first buffer if residual storage space in the first buffer exists after storing the sorted first sample.

10. The method of claim 1, wherein the first sample of state data is received from a reconfigurable emulation resource.

11. The method of claim 1, wherein the step of storing the sorted first sample comprises storing the entire first sample in the current buffer.

12. The method of claim 1, wherein the sorted first sample comprises both data of interest and ignored data.

13. The method of claim 1, wherein the step of sorting the first sample comprises steps of:
identifying a bit of data of interest within the first sample;
identifying a bit position within the first buffer where residual storage space exists; and
sorting the bit of the identified data of interest of the first sample into a bit position of a sorted first sample,
wherein the identified bit position within the first buffer is the bit position of the sorted first sample.

14. The method of claim 13, further comprising steps of:
identifying a next bit position within the first buffer where residual storage space exists; and
sorting at least a second bit of the identified data of interest of the first sample into a next bit position of the sorted first sample,
wherein the next identified bit position within the first buffer is the next bit position of the sorted first sample.

15. The method of claim 13, wherein upon determining that residual storage space in the first buffer does not exist, the method further comprising a step of:
identifying a first bit position of a second buffer where residual storage space exists,
wherein the identified first bit position of the second buffer where residual storage space exists is a first bit position of the sorted first sample.

16. The method of claim 1, further comprising a step of storing information associated with the first sample.

17. The method of claim 16, wherein the information comprises a bit position of data of interest of the first sample.

18. The method of claim 16, wherein the information comprises an identification of a pin associated with the first sample.

19. The method of claim 16, further comprising steps of:
receiving a second sample of state data;
storing the second sample;
storing information associated with the first sample in memory; and
storing information associated with the second sample in memory.

20. An apparatus, comprising:
a first select logic device configured to receive samples of state data, to sort samples of state data, and to select data of interest from each of the samples of state data;
first and second buffers coupled to the first select logic device and configured to receive the selected data of interest;
a second select logic device coupled to the first and second buffers and configured to select the first and second buffers in an alternating manner to drain the selected buffer; and
an output storage device coupled to the second select logic device and configured to receive data drained from the selected buffer.

21. The apparatus of claim 20, wherein the first select logic comprises a multiplexer.

22. The apparatus of claim 20, wherein the second select logic device comprises a multiplexer.

23. The apparatus of claim 20, wherein the first select logic device sends the data of interest to the second buffer when the first buffer becomes full.

24. The apparatus of claim 20, wherein the first select logic device comprises a data of interest sorter.

25. The system of claim 20, further comprising:
a memory configured to store information associated with the samples of state data.

26. The system of claim 25, wherein the information comprises at least a bit position of data of interest of the sample of state data.

27. The system of claim 25, wherein the information comprises an identification of a pin associated with each of the samples of state data.

28. The system of claim 20, wherein the output storage device is configured to store information associated with each of the samples of state data.

29. A method for associating trace data chains with pins of an integrated circuit, the method comprising steps of:
determining a trace data fill rate of each of a plurality of trace data chains; and
determining a schedule for associating a plurality of pins with the plurality of trace data chains to transfer data out of the trace data chains based at least upon the determined trace data chain fill rates.

30. In an emulation debugging resource, a method comprising steps of:
determining fill rates of a plurality of trace data chains;
determining a schedule for associating a plurality of pins with the plurality of trace data chains based at least upon the determined fill rates; and
associating a set of the plurality of trace data chains with the plurality of pins in accordance with the determined schedule.

31. In an integrated circuit, the integrated circuit including an emulator, an apparatus comprising:
a plurality of trace data chains;
a trace pin select logic device coupled to the plurality of trace data chains to select a set of the plurality of trace data chains;
a plurality of pins; and
a memory coupled to the trace pin select logic device and configured to store a schedule to associate the selected set with the pins.
